(19) United States
(12) Patent Application Publication
(10) Pub. No.: US 2003/0056309 A1
(43) Pub. Date: Mar. 27, 2003

(54) Pipeline pig cleaning apparatus

(76) Inventor: Donald D. Savard, Edmonton (CA)

Correspondence Address: DAVID L. DAVIS, ESQ., 203 MAIN STREET, METUCHEN, NJ, 08840, US

(21) Appl. No.: 09/950,011

(22) Filed: Sep. 10, 2001

(30) Foreign Application Priority Data
Sep. 13, 2000 (CA) 2,318,714

(51) Int. Cl. B08B 9/055

(52) U.S. Cl. 15/104.061

(57) ABSTRACT

The invention relates to a pipeline cleaning apparatus adapted to connect to a body of a fluid-propelled pig. The apparatus includes a front end, a back end, a generally circular rim extending around the outer periphery of the apparatus, and a plurality of jetting channels extending through the apparatus and arranged at the rim such that when the apparatus is inside the pipe, some of the propelling fluid received at the back end is discharged under pressure from the front end towards the pipe wall in front of the apparatus, clearing away any debris that has accumulated on the pipe wall. The rim has a diameter that is sufficiently large to contact an inner wall of the pipe, and at least a portion of the apparatus is made of a resilient material.

### FIELD OF THE INVENTION

The present invention relates generally to pipeline pigs and in particular to a pipeline cleaning apparatus for a fluid-propelled pipeline pig.

### BACKGROUND OF THE INVENTION

Pipeline pigs were developed in the 1950's to clear debris from crude oil pipelines. They have now become widely used around the world in pipelines carrying a variety of product fluids but are most commonly used in the oil gas and petrochemical industries.

Pipeline pigs are devices that are inserted into and travel throughout the length of a pipeline driven by a product fluid flow. A pig acts like a free moving piston inside the pipeline, generally sealing against the inside wall with a number of sealing elements. Pigs were originally developed to remove deposits which could obstruct or retard flow through the pipeline. Today, pigs are used during all phases of a pipeline life and for a variety of purposes. For example, utility pigs are used to perform functions such as cleaning, separating, or dewatering. In-line inspection pigs contain equipment that provide information about the condition of the line, as well as the extent and location of any problems in the line. Inspection pigs may have sensor packs that can take a variety of measurements including pipe diameter, curvature, temperature, and pressure, and can detect the presence of cracks, leaks, and wax deposit accumulation.

Utility pipeline pigs can be divided into two groups based on their fundamental purpose, namely cleaning pigs and sealing pigs. Cleaning pigs are used to remove solid or semi-solid deposits or debris from the pipeline, such as wax that tends to accumulate on inside walls of crude oil pipelines. Sealing pigs are used to provide a good seal in order to either sweep liquids from the line, or to act as a plug to allow a portion of the pipeline to be serviced.

A mandrel pig is a type of utility pig that has a central body tube. Different components can be attached to the body tube to configure the pig for different duties. For example, a sealing cup may be attached to the body tube to enable the pig to maintain a fluid seal against the inside pipe wall. To establish the seal, the cup is typically made of a resilient material and is designed with a slightly larger outside diameter than the internal diameter of the pipe, so that nthe cup compresses when the pig is inserted in the pipe and an outer lip the cup forms a seal with the inner wall of the pipe. A pig having at least one such sealing cup can be propelled through a pipe by a product fluid pumped through the pipe under pressure. To enhance the seal, the cup may have a concave surface that faces the trailing end of the pig; with such a shape, the pressure of the product fluid contacting the concave surface serves to increase the sealing force of the lip against the pipe wall.

The sealing cup may be attached to the leading end of the body tube and be used as a scraper cup to scrape wax and other debris off the interior walls of a pipeline. As a pig equipped with such a cup moves through the pipe, wax tends to build up in front of the leading surface of the cup. Eventually, the wax build-up increases to a point that movement of the pig causes the sealing force between the lip and the pipe wall to break. Once the seal is broken, wax tends to slide between the annular lip of the sealing cup and the pipe wall, and the pig leaves behind a layer of unscraped wax as it moves through the pipe.

### SUMMARY OF THE INVENTION

According to one aspect of the invention, there is provided a pipeline cleaning apparatus adapted to connect to a body of a fluid-propelled pig. The apparatus comprises a front end, a back end, a generally circular rim portion extending around the outer periphery of the apparatus for contacting an inner wall of a pipe, and a plurality of jetting channels extending through the apparatus and arranged at the rim such that when the apparatus is inside the pipe, some of the propelling fluid received at the back end is discharged under pressure from the front end towards the pipe wall in front of the apparatus. At least a portion of, but preferably the entire apparatus is made of a resilient material, preferably polyethylene.

The apparatus may have channels that taper radially such that a channel opening at the back end has a radial depth that is deeper than the radial depth of a channel opening at the front end of the apparatus. The tapering is designed to compensate for the tendency for the back end of the apparatus to wear faster than the front end, by allowing fluid to flow through the channel even if more radial depth of the channel has worn away at the back end relative to the front end. Also, the apparatus may have channels that extend between the front and back ends at an angle from the rim axial direction. Fluid flow through such angled channels spins the apparatus as the pig travels through the pipeline, thereby promoting even wear of the rim and improving the scraping efficiency.

The apparatus may be cup-shaped, and have a generally circular base and a circumferential cup wall extending from the cup base and terminating at the rim. Furthermore, the cup wall may have a frusto-conical shape such that the outside rim diameter is larger than the base diameter The channels may be grooves located in the outside surface of the cup wall.

The apparatus may also be disc-shaped, and have a circumferential wall at the outer periphery of the apparatus. In such an apparatus, the channels may be grooves located in the surface of the disc wall. The disc wall may have a cylindric or slightly forwardly tapering frusto-conical shape.

### BRIEF DESCRIPTION OF THE DRAWINGS

FIG. 1 is a schematic side view of a prior art pipeline pig moving through the inside of a pipeline.

FIG. 2 is a schematic end view of a scraper cup according to one embodiment of the invention.

FIG. 3 is a schematic side view of the scraper cup of FIG. 2, along the lines A-A of FIG. 2.

FIG. 4 is schematic side view of a pipeline pig moving through the inside of a pipeline and having a pair of scraper cups of FIG. 2 connected to a central pig body.

FIG. 5 is a schematic side view of a part of a scraper cup according to an alternative embodiment of the invention.

FIG. 6 is schematic top view of a scraper cup according to an alternative embodiment of the invention.

FIG. 7 is a schematic side view of a scraper disc according to an alternative embodiment of the invention.

### DETAILED DESCRIPTION

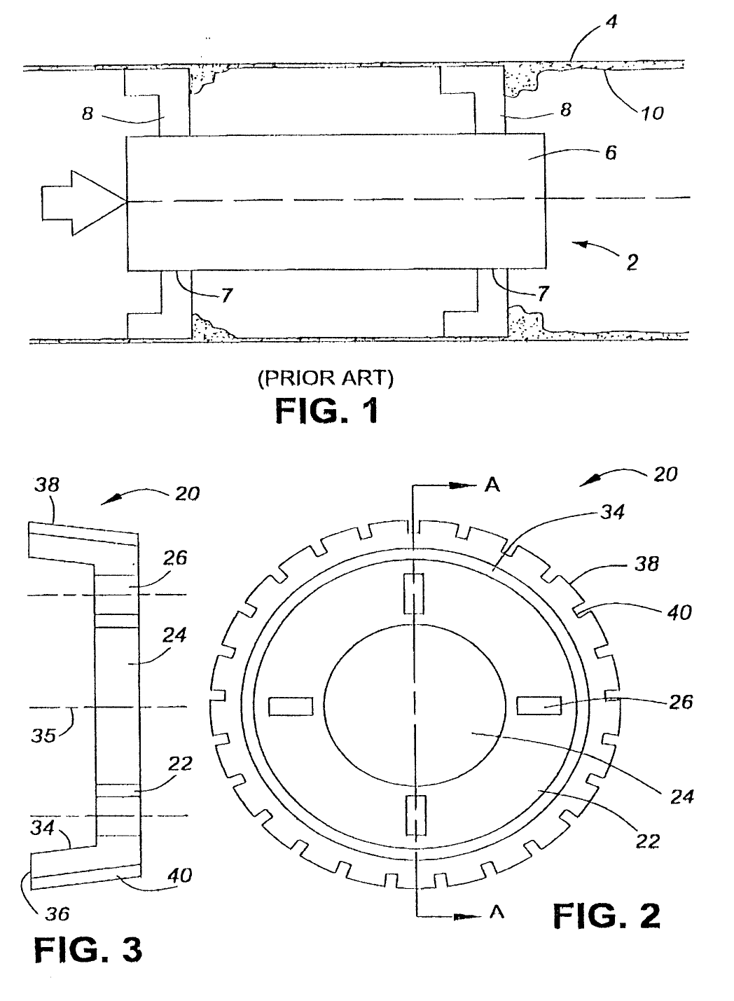

Referring to FIG. 1, a conventional (prior art) pipeline pig 2 is shown inside a pipe 4. The pig 2 has a main pig body 6 in the form of an elongated tube that enables the mounting of various components thereto. A pair of sealing cups 8 are mounted near each end of the pig body 6. The cups 8 are each made of a resilient material such as polyurethane, and have a circular opening 7 with a diameter that is large enough to allow the pig body 6 to fit through the cup 8. Conventional sealing means such as an O-ring (not shown) may be provided at each opening 7 to form a seal between the pig body 6 and each cup 8. Each cup 8 may be fastened to the pig body 6 by a number of different well known means (not shown).

Each cup 8 may be designed with an outside diameter that is slightly larger than the inside diameter of the intended pipe 4. When the pig 2 is inserted inside the pipe 4, each cup 8 compresses and a fluid seal is formed between each cup 8 and the pipe wall 4. A product fluid such as oil or gas is used to propel the pig 2 through the pipe 4. The product fluid is pumped through the pipe 4 at a pressure that overcomes the frictional resistance between the cups 8 and the pipe wall 4, and causes the pig 2 to move along the pipe 4 in the direction indicated by the arrow in FIG. 1. As the pig 2 travels inside the pipe 4, the cup 8 located near the leading end of the pig 2 (“leading cup”) scrapes debris 10 off the inside pipe wall 4, and the removed debris 10 collects on the leading end of the pig 2. Eventually, the amount of debris accumulated overcomes the sealing force between the leading cup 8 and the pipe wall 4, and debris 10 squeezes by the leading cup 8 and starts to collect in front of the trailing cup 8. Once the build-up of debris 10 over the trailing cup 8 overcomes the seal between the trailing cup 8 and the pipe wall 4, a layer of unscraped debris will be left behind by the pig 2 as it passes through the pipe 4.

Referring to FIGS. 2 to 4, and according to one embodiment of the invention, a scraper cup 20 is provided for attaching to one or both ends of the pig body 6. The scraper cup 20 has a base 22 and a wall 34 connected to the base 22. A pig body opening 24 is provided through the center of the base 22, and is shaped and dimensioned to allow the scraper cup 20 to snugly slide over the pig body 6.

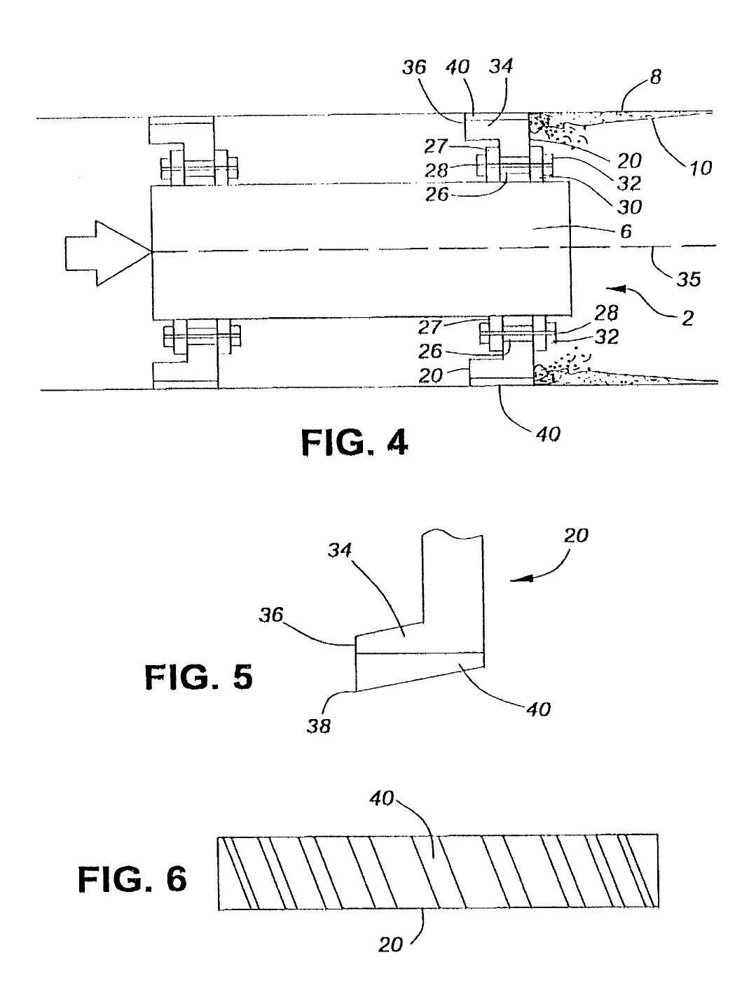

A series of mounting holes 26 in the base 22 are arranged circumferentially around the pig body opening 24, Referring to FIG. 4, an annular flange 27 extending from the surface of the pig body 6 is provided with openings that line up with the cup mounting holes 26 when the cup 20 is slid over the pig body 6 and up against the flange 27. Threaded mounting bolts 28 passing through the flange openings and cup mounting holes 26 are secured by nuts 32, thereby securing the cup 20 to the pig body 6. An annular sealing ring 30 may be provided with matching mounting holes for abutting against the cup 20 to seal the mounting holes 26.

The number of mounting holes may be varied depending an the shape and size of the cup 20, and other means for attaching the scraper cup 20 to the pig body 6 such as rivets, screws, adhesives, etc, will readily occur to one skilled in the art and may be substituted within the spirit of the invention.

The cup wall 34 has a frusto-conical shape and as such flares outwards from the cup base 22 at a slight angle from the cup axis 35 to terminate at a rim 36. As a result, the outside diameter of the rim 36 (the outside edge of the rim herein referred to as a rim lip 38) is larger than the diameter of the cup base 22. The diameter of the cup base 22 is selected to be as close as possible to the inside diameter of the intended pipe 4. When the pig 2 is inserted into the pipe 4 as shown in FIG. 4, at least a portion of the cup wall 34 contacts the pipe wall 4 and bends to conform and become generally parallel with the pipe wall 4. The pressure exerted by the cup wall 34 on the pipe wall 4 establishes firm contact between the cup 20 and the pipe wall 4. The magnitude of the pressure depends of the stiffness of the cup material.

The cup 20 is mounted to the pig body 6 such that the rim 36 faces the trailing end of the pig body 6, i.e. the cup is concave to the product fluid. This arrangement enables the pressure of the product fluid contacting the trailing surfaces of the cup 20 to increase the pressure exerted by the cup wall 34 against the pipe wall 4.

The cup is typically made from a resilient polyurethane. The appropriate type of the polyurethane is determined by the supplier of polyurethane, and depends on many variables such as the type of product fluid, temperature etc. The cup 20 may serve a dual function to support and guide the pig 2 through the pipe as well as scrape debris from the pipe wall 4; in such case, the cup 20 is made of a resilient material that is sufficiently stiff for the cup 20 to support the pig body 6 as it travels inside the pipe 4.

Extended frictional contact between the cup wall 34 moving against the pipe 4 will cause the cup wall 34 to wear down. The length of the cup wall 34 may be varied depending on the wear characteristics a manufacturer wishes to achieve; generally, a longer cup wall provides longer wear resistance, but requires more material and is thus more expensive to produce. Therefore, the manufacturer will select a cup with dimensions that take into consideration both cost and performance.

Referring again to FIGS. 2 and 3, fluid jetting grooves 40 are spaced around the circumference of the rim 36. Each groove 40 extends along the length of the cup wall 34, and resembles an open-faced channel in the cup wall 34. When the cup wall 34 comes into firm contact with the pipe wall 4, the pipe wall 4 closes the open longitudinal face of the each groove 40, thereby providing a fluid conduit between the two open ends of each groove 40. Alternatively, channels (not shown) may be provided in place of the grooves 40. These channels are located completely within the wall in close proximity to the wall periphery, and like the grooves 40, extend along the length of the wall 34 to provide a fluid conduit through the cup 20.

FIG. 4 shows a pig 2 having a pair of cups 20 mounted at each end of the pig body 6 (for ease of reference in this description, the cups at the leading and trailing ends of the pig may be referred to as the “leading” and “trailing” cups, respectively; also, parts of the pig 2 facing the leading and trailing ends may be referred to as being “front” and “back” parts, respectively).

In operation, the pig 2 moves through the inside of the pipe 4 under pressure from the product fluid contacting the trailing end of the pig 2. Product fluid will also enter via grooves 40 in the trailing cup 20 into a cavity defined by the leading and trailing cups 20 and the pipe wall 4 and pig body 6. Once sufficient pressure has built up inside this cavity, jets of product fluid will pass through the grooves 40 in the leading cup 20 and be discharged in front of the pig 2. These jets of product fluid disperse wax or debris 10 that may have accumulated on the front of the pig 2 while the pig 2 travels through the pipe 4, thereby preventing a build-up of debris 10 that would overcome the contact between the cup wail 34 and the pipe wall 4.

The grooves 40 are positioned so that when the cup 20 is inside the pipe 4, the grooves 40 direct jets of fluid towards the pipe wall 4 in front of the pig body 6. The groove characteristics, such as the number of and spacing of grooves 40 in each cup 20, and the size an shape of each groove opening, can be varied depending on the operating conditions, The manufacturer will have in mind when selecting these characteristics various factors, such as the expected pressure of the product fluid, and the amount and viscosity of the debris in the pipe 4. For example, for a cup to be installed in a pig 2 propelled by crude oil under normal operating pressures, wherein the cup has an base diameter of 20″, there may be twenty-five channels spaced about 2.5″ apart around the rim 38, with each groove 40 having a typical width of about ¼″ and a depth of ¼″.

During operation, the cup wall 34 portion near the rim 36 tends to wear down before the cup wall 34 portion near the cup base 22. In a worn-down cup 20 having constant-depth groove 40, fluid flow may be impeded near the rim end. Referring to FIG. 5 and according to an alternative embodiment of the invention, each groove 40 may be tapered radially so that the groove depth near the rim 36 is larger than groove depth near the cup base 22. For the example cup described above, each groove 40 may have a depth of ⅜″ at the rim 36 and taper to a depth of ¼″ at the cup base 22. This arrangement is expected to increase the operational life of the scraper cup 20, as the extra depth near the rim 36 should allow fluid to flow through the cup 20 even after a substantial portion of the cup wall 34 near the rim 36 has worn away.

According to an another alternative embodiment of the invention and referring to FIG. 6, the channels 40 may be arranged at an angle from cup axial direction 35, such that a tangential force is exerted on the cup 20 when fluid is discharged. The tangential force exerted by the discharged fluid and the contact between the angled grooves at the pipe wall 4 encourage the cup 20 to spin while the pig 2 moves through the pipe 4. It is expected that the rotation of the cup 20 will promote uniform wearing of the cup wells 34 and will improve the scraping efficiency.

While FIG. 4 illustrates a pair of scraper cups 20 attached to the pig body 6, a conventional sealing/scraper cup may instead be attached at the trailing end and replace trailing cup 20, so long as fluid passages are provided through the cup to allow sufficient fluid pressure to build up inside the cavity between the leading and trailing cups, and to enable a fluid discharge that is strong enough to disperse debris 10 collected at the front of the cup 20.

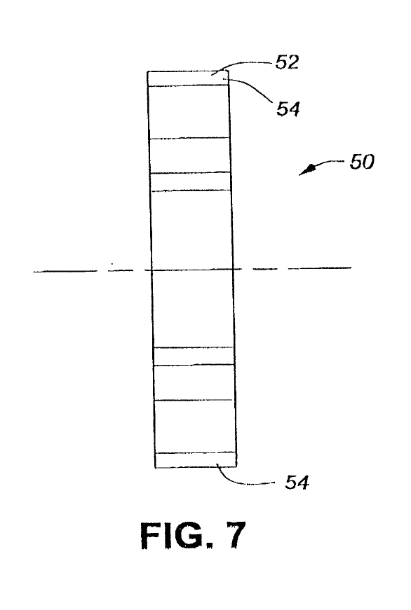

According to another embodiment of the invention and referring to FIG. 7, the scraper cup may be manufactured without a cup wall, and thus resemble a disc 50 (and more appropriately be referred to as a “scraper disc”). The scraper disc 50 has a circumferential wall 52 that extends around the outer periphery of the disc 50, and has a shape and dimensions that enable at least a portion of the wall 52 to contact a pipe wail 4. Fluid jetting grooves 54 in the surface of the wall 52 extend between the front and back surfaces of the disc 50. The scraper disc 50 may be concave to enable the pressure from the product fluid to add to the contact pressure by the disc edge on the pipe wall. Also, the disc wall 52 may be cylindrical, or frusto-conical.

Other alternatives and variants of the above-described apparatus differing from the embodiments described, without departing from the scope of the present invention as set forth in the accompanying claims.

1. A pipeline cleaning apparatus adapted to connect to a body of a fluid-propelled pig, the apparatus comprising
(a) a front end;
(b) a back end;
(c) a generally circular rim extending around the outer periphery of the apparatus, for contacting an inner wall of a pipe, and
(d) a plurality of jetting channels extending through the apparatus and arranged at the rim such that when the apparatus is inside the pipe, some of the propelling fluid received at the back end is discharged under pressure from the front end towards the pipe wall in front of the apparatus; and,
wherein at least a portion of the apparatus is made of a resilient material.

2. The apparatus of claim 1 wherein the channels taper radially such that the channels are deeper at the back end than at the front end.

3. The apparatus of claim 1 wherein the channels extend between the front and back ends at an angle from the rim axial direction.

4. The apparatus of claim 1 wherein the apparatus is cup-shaped, having a generally circular base and a circumferential cup wall extending from the cup base and terminating at the rim.

5. The apparatus of claim 4 wherein the cup wall has a frusto-conical shape such that the outside rim diameter is larger than the base diameter.

6. The apparatus of claim 5 wherein the channels are grooves located in the outside surface of the cup wall.

7. The apparatus of claim 1 wherein the apparatus is disc-shaped and includes a leading face, a trailing face and a circumferential wall extending between said faces at the outer periphery of the apparatus.

8. The apparatus of claim 7 wherein the channels are grooves located in the surface of the disc wall.

9. The apparatus of claim 8 wherein the circumferential wall has a frusto-conical shape.

10. A disc-shaped pipeline cleaning apparatus adapted to connect to a body of a fluid-propelled pig, comprising
(a) a front surface;
(b) a back surface;
(c) a circumferential wall at the outer periphery of the apparatus, for contacting an inner wall of a pipe, and
(d) a plurality of jetting grooves extending between the front and back surfaces and in the surface of the wall, the grooves arranged such that when the apparatus is inside the pipe, some of the propelling fluid received at the back surface is discharged under pressure from the front surface towards the pipe wall in front of the apparatus; and,
wherein at least a portion of the apparatus is made of a resilient material.

11. The apparatus of claim 10 wherein the grooves extend between the front and back surfaces at an angle from the disc axial direction.

12. The apparatus of claim 10 wherein the grooves taper radially such that the grooves are deeper at the back surface than at the front surface.

13. The apparatus of claim 10 wherein the disc wall has a frusto-conical shape.

14. A cup-shaped pipeline cleaning apparatus adapted to connect to a body of a fluid-propelled pig, comprising
(a) a generally circular base having a front surface and a back surface;
(b) a circumferential cup wall extending from the base and terminating at a rim, at least a portion of the wall for contacting an inner wall of a pipe, and
(c) a plurality of jetting grooves in the outside surface of the cup wall and extending along the length of the wall, the grooves arranged such that when the apparatus is inside the pipe, some of the propelling fluid received at the rim is discharged under pressure from the front surface of the base towards the pipe wall in front of the apparatus; and,
wherein at least a portion of the apparatus is made of a resilient material.

15. The apparatus of claim 14 wherein the grooves taper radially such that the grooves are deeper at the rim than at the base.

16. The apparatus of claim 14 wherein the channels extend between the rim and front surface of the base at an angle from the rim axial direction.

17. The apparatus of claim 14 wherein the cup wall has a frusto-conical shape such that the outside rim diameter is larger than the base diameter.
